(19) United States
(12) Patent Application Publication
(10) Pub. No.: US 2010/0208981 A1
(43) Pub. Date: Aug. 19, 2010

(54) Method for visualization of point cloud data based on scene content

(75) Inventors: Kathleen Minear, Palm Bay, FL (US); Anthony O'Neil Smith, Melbourne, FL (US); Katie Gluvna, Palm Bay, FL (US)

Correspondence Address: HARRIS CORPORATION;C/O FOX ROTHSCHILD, LLP, 997 Lenox Drive, Building 3, Lawrenceville, NJ, 08543-5231, US

(73) Assignee: Harris Corporation, Melbourne, FL (US)

(21) Appl. No.: 12/378,353

(22) Filed: Feb. 13, 2009

(51) Int. Cl. G06T 15/50; G06K 9/00

(52) U.S. Cl. 382/154; 345/426

(57) ABSTRACT

Systems and methods for associating color with spatial data are provided. In the system and method, a scene tag is selected for a portion 804 of a radiometric image data (800) of a location and a portion of the spatial data (200) associated with the first portion of the radiometric image data is selected. Based on the scene tag, a color space function (500, 600) for the portion of the spatial data is selected, where the color space function defines hue, saturation, and intensity (HSI) values as a function of an altitude coordinate of the spatial data. The portion of the spatial data is displayed using the HSI values selected from the color space function based on the portion of the spatial data. In the system and method, scene tags are each associated different classifications, where each color space function represents a different pre-defined variation in the HSI values for an associated classification.

### BACKGROUND OF THE INVENTION

1. Statement of the Technical Field

The present invention is directed to the field of visualization of point cloud data, and more particularly for visualization of point cloud data based on scene content.

2. Description of the Related Art

Three-dimensional (3D) type sensing systems are commonly used to generate 3D images of a location for use in various applications. For example, such 3D images are used creating a safe training or planning environment for military operations or civilian activities, for generating topographical maps, or for surveillance of a location. Such sensing systems typically operate by capturing elevation data associated with the location. One example of a 3D type sensing system is a Light Detection And Ranging (LIDAR) system. LIDAR type 3D sensing systems generate data by recording multiple range echoes from a single pulse of laser light to generate a frame sometimes called image frame. Accordingly, each image frame of LIDAR data will be comprised of a collection of points in three dimensions (3D point cloud) which correspond to the multiple range echoes within sensor aperture. These points can be organized into “voxels” which represent values on a regular grid in a three dimensional space. Voxels used in 3D imaging are analogous to pixels used in the context of 2D imaging devices. These frames can be processed to reconstruct a 3D image of the location. In this regard, it should be understood that each point in the 3D point cloud has an individual x, y and z value, representing the actual surface within the scene in 3D.

To further assist interpretation of the 3D point cloud, colormaps have been used to enhance visualization of the point cloud data. That is, for each point in a 3D point cloud, a color is selected in accordance with a predefined variable, such as altitude. Accordingly, the variations in color are generally used to identify points at different heights or at altitudes above ground level. Notwithstanding the use of such conventional colormaps, 3D point cloud data has remained difficult to interpret.

### SUMMARY OF THE INVENTION

Embodiments of the present invention provide systems and method for visualization of spatial or point cloud data using colormaps based on scene content. In a first embodiment of the present invention, a method for improving visualization and interpretation of spatial data of a location. The method includes selecting a first scene tag from a plurality of scene tags for a first portion of a radiometric image data of the location and selecting a first portion of the spatial data, where the spatial data includes a plurality of three-dimensional (3D) data points associated with the first portion of the radiometric image data. The method also includes selecting a first color space function for the first portion of the spatial data from a plurality of color space functions, the selecting based on the first scene tag, and each of the plurality of color space functions defining hue, saturation, and intensity (HSI) values as a function of an altitude coordinate of the plurality of 3D data points. The method further includes displaying the first portion of the spatial data using the HSI values selected from the first color space function using the plurality of 3D data points associated with the first portion of the spatial data. In the method, the plurality of scene tags are associated with a plurality of classifications, where each of the plurality of color space functions represents a different pre-defined variation in the HSI values associated one of the plurality of classifications.

In a second embodiment of the present invention, a system for improving visualization and interpretation of spatial data of a location is provided. The system includes a storage element for receiving the spatial data and radiometric image data associated with the location and a processing element communicatively coupled to the storage element. In the system, the processing element is configured for selecting a first scene tag from a plurality of scene tags for a first portion of a radiometric image data of the location and selecting a first portion of the spatial data, the first portion of the spatial data includes a plurality of three-dimensional (3D) data points associated with the first portion of the radiometric image data. The processing element is also configured for selecting a first color space function for the first portion of the spatial data from a plurality of color space functions, the selecting based on the first scene tag, and each of the plurality of color space functions defining hue, saturation, and intensity (HSI) values as a function of an altitude coordinate of the plurality of 3D data points. The system is further configured for displaying the first portion of the spatial data using the HSI values selected from the first color space function using the plurality of 3D data points associated with the first portion of the spatial data. In the system, the plurality of scene tags are associated with a plurality of classifications, where each of the plurality of color space functions represents a different pre-defined variation in the HSI values associated one of the plurality of classifications.

In a third embodiment of the present invention, a computer-readable medium, having stored thereon a computer program for improving visualization and interpretation of spatial data of a location is provided. The computer program includes a plurality of code sections, the plurality of code sections executable by a computer. The computer program includes code sections for selecting a first scene tag from a plurality of scene tags for a first portion of a radiometric image data of the location and selecting a first portion of the spatial data, the spatial data includes a plurality of three-dimensional (3D) data points associated with the first portion of the radiometric image data. The computer program also includes code sections for selecting a first color space function for the first portion of the spatial data from a plurality of color space functions, the selecting based on the first scene tag, and each of the plurality of color space functions defining hue, saturation, and intensity (HSI) values as a function of an altitude coordinate of the plurality of 3D data points. The computer program further includes code sections for displaying the first portion of the spatial data using the HSI values selected from the first color space function using the plurality of 3D data points associated with the first portion of the spatial data. In the computer program, the plurality of scene tags are associated with a plurality of classifications, where each of the plurality of color space functions represents a different pre-defined variation in the HSI values associated one of the plurality of classifications.

### BRIEF DESCRIPTION OF THE DRAWINGS

FIG. 1 shows an exemplary data collection system for collecting 3D point cloud data in accordance with an embodiment of the present invention.

FIG. 2 shows an exemplary image frame containing 3D point cloud data acquired in accordance with an embodiment of the present invention.

FIG. 3A shows an exemplary view of an urban location illustrating the types of objects commonly observed within an urban location.

FIG. 3B shows an exemplary view of a natural or rural location illustrating the types of objects commonly observed within natural or rural locations.

FIG. 4A is a drawing that is useful for understanding certain defined altitude or elevation levels contained with a natural or rural location.

FIG. 4B is a drawing that is useful for understanding certain defined altitude or elevation levels contained with an urban location.

FIG. 5 is a graphical representation of an exemplary normalized colormap for use in an embodiment of the present invention for a natural area or location based on an HSI color space which varies in accordance with altitude or height above ground level.

FIG. 6 is a graphical representation of an exemplary normalized colormap for use in an embodiment of the present invention for an urban area or location based on an HSI color space which varies in accordance with altitude or height above ground level.

FIG. 7 shows an alternate representation of the colormaps in FIGS. 5 and 6.

FIG. 8A shows an exemplary radiometric image acquired in accordance with an embodiment of the present invention.

FIG. 8B shows the exemplary radiometric image of FIG. 8A after feature detection is performed in accordance with an embodiment of the present invention.

FIG. 8C shows the exemplary radiometric image of FIG. 8A after feature detection is and region definition is performed in accordance with an embodiment of the present invention.

FIG. 9A shows a top-down view of 3D point cloud data 900 associated with the radiometric image in FIG. 8A after the addition of color data in accordance with an embodiment of the present invention.

FIG. 9B shows a perspective view of 3D point cloud data 900 associated with the radiometric image in FIG. 8A after the addition of color data in accordance with an embodiment of the present invention.

FIG. 10 shows an exemplary result of a spectral analysis of a radiometric image in accordance with an embodiment of the present invention.

FIG. 11A shows a top-down view of 3D point cloud data after the addition of color data based on a spectral analysis in accordance with an embodiment of the present invention.

FIG. 11B shows a perspective view of 3D point cloud data after the addition of color data based on a spectral analysis in accordance with an embodiment of the present invention.

FIG. 12 illustrates how a frame containing a volume of 3D point cloud data can be divided into a plurality of sub-volumes.

### DETAILED DESCRIPTION

The present invention is described with reference to the attached figures, wherein like reference numerals are used throughout the figures to designate similar or equivalent elements. The figures are not drawn to scale and they are provided merely to illustrate some embodiments of the present invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

A 3D imaging system generates one or more frames of 3D point cloud data. One example of such a 3D imaging system is a conventional LIDAR imaging system. In general, such LIDAR systems use a high-energy laser, optical detector, and timing circuitry to determine the distance to a target. In a conventional LIDAR system one or more laser pulses is used to illuminate a scene. Each pulse triggers a timing circuit that operates in conjunction with the detector array. In general, the system measures the time for each pixel of a pulse of light to transit a round-trip path from the laser to the target and back to the detector array. The reflected light from a target is detected in the detector array and its round-trip travel time is measured to determine the distance to a point on the target. The calculated range or distance information is obtained for a multitude of points comprising the target, thereby creating a 3D point cloud. The 3D point cloud can be used to render the 3-D shape of an object.

In general, interpreting 3D point cloud data to identify objects in a scene can be difficult. Since the 3D point cloud specifies only spatial information with respect to a reference location, at best only height and shape of objects in a scene is provided. Some conventional systems also provide an intensity image along with the 3D point cloud data to assist the observer in ascertaining height differences. However, the human visual cortex typically interprets objects being observed based on a combination of information about the scene, including the shape, the size, and the color of different objects in the scene. Accordingly, a conventional 3D point cloud, even if associated with an intensity image, generally provides insufficient information for the visual cortex to properly identify many objects imaged by the 3D point cloud. In general, the human visual cortex operates by identifying observed objects in a scene based on previously observed objects and previously observed scenes. As a result, proper identification of objects in a scene by the visual cortex relies on not only on identifying properties of an object, but also identifying known associations between different types of objects in a scene.

To overcome the limitations of conventional 3D point cloud display systems and to facilitate the interpretation of 3D point cloud data by the human visual cortex, embodiments of the present invention provide systems and methods for applying different colormaps to different areas of the 3D point cloud data based on a radiometric image. In particular, different colormaps, associated with different terrain types, are associated with the 3D point cloud data according to tagging or classification of associated areas in an radiometric image. For example, if an area of the radiometric image shows an area of man-made terrain (e.g., an area where the terrain is dominated by artificial or man-made features such as buildings, roadways, vehicles), a colormap associated with a range of colors typically observed in such areas is applied to a corresponding area of the 3D point cloud. In contrast, if an area of the radiometric image shows an area of natural terrain (e.g., an area dominated by vegetation or other natural features such as water, trees, desert), colormaps associated with a range of colors typically observed in these types of areas is applied to a corresponding area of the 3D point cloud. As a result, by applying different colormaps to different portions of the 3D point cloud, colors that are more likely associated with the shapes of objects in the different portions of the 3D point cloud are presented to the observer and are more easily recognizable by the human visual cortex.

The term “radiometric image”, as used herein, refers to an two-dimensional representation (an image) of a location obtained by using one or more sensors or detectors operating on one or more electromagnetic wavelengths.

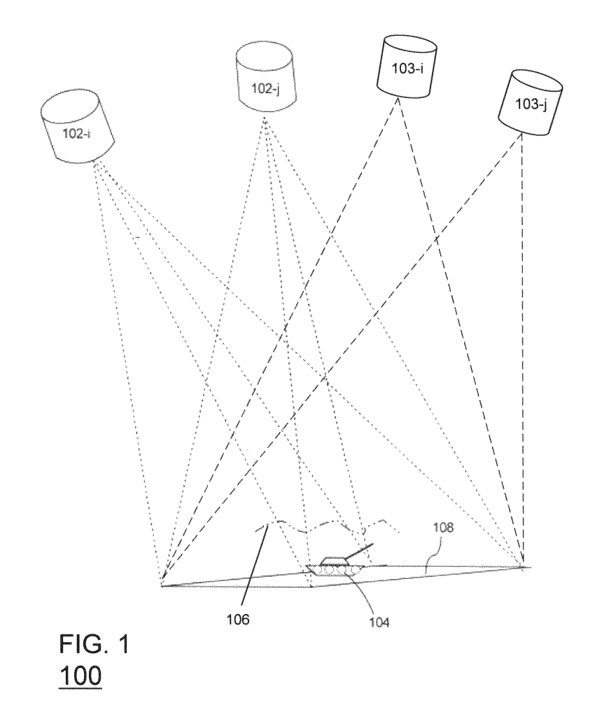

An exemplary data collection system 100 for collecting 3D point cloud data and associated image data according to an embodiment of the present invention is shown in FIG. 1. As shown in FIG. 1, a physical volume 108 to be imaged can contain one or more objects 104, 106, such as trees, vehicles, and buildings. For purposes of the present invention, the physical volume 108 can be understood to be a geographic location. For example, the geographic location can be a portion of a jungle or forested area having trees or a portion of a city or town having numerous buildings or other artificial structures.

In the various embodiments of the inventions, the physical volume 108 is imaged using a variety of different sensors. As shown in FIG. 1, 3D point cloud data can be collected using one or more sensors 102-i, 102-j and the data for an associated radiometric image can be collected using one other radiometric image sensors 103-i, 103-j. The sensors 102-i, 102-j, 103-i, and 103-j can be any remotely positioned sensor or imaging device. For example, the sensors 102-i, 102-j, 103-i, and 103-j can be positioned to operate on, by way of example and not limitation, an elevated viewing structure, an aircraft, a spacecraft, or a celestial object. That is, the remote data is acquired from any position, fixed or mobile, that is elevated with respect to the physical volume 108. Furthermore, although sensors 102-i, 102-j, 103-i, and 103-j are shown as separate imaging systems, two or more of sensors 102-i, 102-j, 103-i, and 103-j can be combined into a single imaging system. Additionally, a single sensor can be configured to obtain the data at two or more different poses. For example, a single sensor on an aircraft or spacecraft can be configured to obtain image data as it moves over the physical volume 108.

In some instances, the line of sight between sensors 102-i and 102-j and an object 104 may be partly obscured by another object (occluding object) 106. In the case of a LIDAR system, the occluding object 106 can comprise natural materials, such as foliage from trees, or man made materials, such as camouflage netting. It should be appreciated that in many instances, the occluding object 106 will be somewhat porous in nature. Consequently, the sensors 102-i, 102-j will be able to detect fragments of object 104 which are visible through the porous areas of the occluding object 106. The fragments of the object 104 that are visible through such porous areas will vary depending on the particular location of the sensor.

By collecting data from several poses, such as at sensors 102-i and 102-j, an aggregation of 3D point cloud data can be obtained. Typically, aggregation of the data occurs by means of a registration process. The registration process combines the data from two or more frames by correcting for variations between frames with regard to sensor rotation and position so that the data can be combined in a meaningful way. As will be appreciated by those skilled in the art, there are several different techniques that can be used to register this data. Subsequent to such registration, the aggregated 3D point cloud data from two or more frames can be analyzed to improve identification of an object 104 obscured by an occluding object 106. However, the embodiments of the present invention are not limited solely to aggregated data. That is, the 3D point cloud data can be generated using multiple image frames or a single image frame.

In the various embodiments of the present invention, the radiometric image data collected by sensors 103-j and 103-j can include intensity data for an image acquired from various radiometric sensors, each associated with a particular range of wavelengths (i.e., a spectral band). Therefore, in the various embodiments of the present invention, the radiometric image data can include multi-spectral (˜4 bands), hyper-spectral (>100 bands), and/or panchromatic (single band) image data. Additionally, these bands can include wavelengths that are visible or invisible to the human eye.

In the various embodiments of the present invention, aggregation of 3D point cloud data or fusion of multi-band radiometric images can be performed using any type of aggregation or fusion techniques. The aggregation or fusion can be based on registration or alignment of the data to be combined based on meta-data associated with the 3D point cloud data and the radiometric image data. The meta-data can include information suitable for facilitating the registration process, including any additional information regarding the sensor or the location being imaged. By way of example and not limitation, the meta-data includes information identifying a date and/or a time of image acquisition, information identifying the geographic location being imaged, or information specifying a location of the sensor. For example, information indentifying the geographic location being image can include geographic coordinates for the four corners of a rectangular image can be provided in the meta-data.

Although, the various embodiments of the present invention will generally be described in terms of one set of 3D point cloud data for a location being combined with a corresponding set of one radiometric image data set associated with the same location, the present invention is not limited in this regard. In the various embodiments of the present invention, any number of sets of 3D point cloud data and any number of radiometric image data sets can be combined. For example, mosaics of 3D point cloud data and/or radiometric image data can be used in the various embodiments of the present invention.

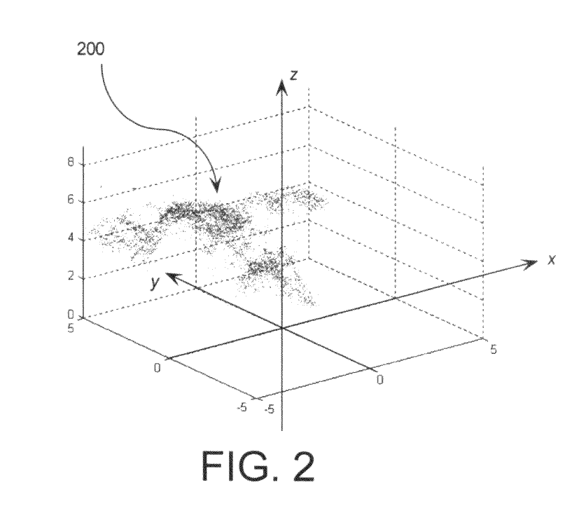

FIG. 2 is exemplary image frame containing 3D point cloud data 200 acquired in accordance with an embodiment of the present invention. In some embodiments of the present invention, the 3D point cloud data 200 can be aggregated from two or more frames of such 3D point cloud data obtained by sensors 102-i, 102-j at different poses, as shown in FIG. 1, and registered using a suitable registration process. As such, the 3D point cloud data 200 defines the location of a set of data points in a volume, each of which can be defined in a three-dimensional space by a location on an x, y, and z axis. The measurements performed by the sensors 102-i, 102-j and any subsequent registration processes (if aggregation is used) are used define the x, y, z location of each data point. That is, each data point is associated with a geographic location and an elevation.

In the various embodiments of the present invention, 3D point cloud data is color coded for improved visualization. For example, a display color of each point of 3D point cloud data is selected in accordance with an altitude or z-axis location of each point. In order to determine which specific colors are displayed for points at various z-axis coordinate locations, a colormap can be used. For example, a red color could be used for all points located at a height of less than 3 meters, a green color could be used for all points located a heights between 3 meters and 5 meters, and a blue color could be used for all points located above 5 meters. A more detailed colormap can use a wider range of colors which vary in accordance with smaller increments along the z axis. Although the use of a colormap can be of some help in visualizing structure that is represented by 3D point cloud data, applying a single conventional colormap to all points in the 3D point cloud data is generally not effective for purposes of improving visualization. First of all, providing a range of colors that is too wide, such as in a conventional red, green, blue (RGB) colormap, provides a variation the color coding for the 3D point cloud that is incongruent with color variation typically observed in objects. Second, providing a single conventional colormap provides incorrect coloring for some types of scenes. Accordingly, embodiments of the present invention instead provide improved 3D point cloud visualization that uses multiple colormaps for multiple types of terrain in an imaged location, where the multiple colormaps can be tuned for different types of features (i.e. buildings, trees, roads, water) typically associated with the terrain. Such a configuration allows different areas of the 3D point cloud data to be color coded using colors for each area that are related to the type of objects in the areas, allowing improved interpretation of the 3D point cloud data by the human visual cortex.

Although any types of different colormaps can be used, in some embodiments of the present invention non-linear colormaps defined in accordance with hue, saturation and intensity (HSI color space) can be used for each type of scene. As used herein, “hue” refers to pure color, “saturation” refers to the degree or color contrast, and “intensity” refers to color brightness. Thus, a particular color in HSI color space is uniquely represented by a set of HSI values (h, s, i) called triples. The value of h can normally range from zero to 360° (0°≦h≦360°. The values of s and i normally range from zero to one (0≦s, ≦1), (0≦i≦1). For convenience, the value of h as discussed herein shall sometimes be represented as a normalized value which is computed as h/360.

Significantly, HSI color space is modeled on the way that humans generally perceive color and can therefore be helpful when creating different colormaps for visualizing 3D point cloud data for different scenes. Furthermore, HSI triples can easily be transformed to other colors space definitions such as the well known RGB color space system in which the combination of red, green, and blue “primaries” are used to represent all other colors. Accordingly, colors represented in HSI color space can easily be converted to RGB values for use in an RGB based device. Conversely, colors that are represented in RGB color space can be mathematically transformed to HSI color space. An example of this relationship is set forth in the table below:

| RGB | his | Result |
|---|---|---|
| (1, 0, 0) | (0°, 1, 0.5) | Red |
| (0.5, 1, 0.5) | (120°, 1, 0.75) | Green |
| (0, 0, 0.5) | (240°, 1, 0.25) | Blue |

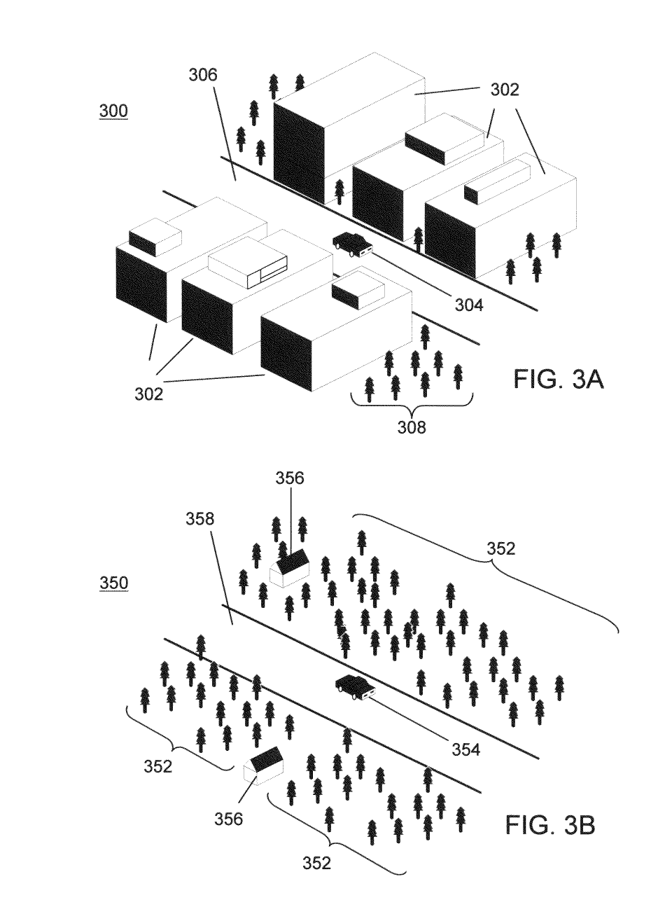

As described above, one of the difficulties in interpreting 3D point cloud data is that the human visual cortex generally expects a particular range of colors to be associated with a particular type of terrain being observed. This is conceptually illustrated with respect to FIGS. 3A and 3B. FIG. 3A shows an exemplary view of an urban location 300 illustrating the types of objects or features commonly observed within an urban location 300. FIG. 3B shows an exemplary view of a natural or rural location 350 illustrating the types of objects or features commonly observed within natural or rural locations 350. As shown in FIG. 3A, an urban area 300 will generally be dominated by artificial or man-made features, such as buildings 302, vehicles 304, and roads or streets 306. To a significantly lesser extent, the urban area 300 can include vegetation areas 308, such as areas including plants and trees. In contrast, a natural area 350, as shown in FIG. 3B will generally be dominated by vegetation areas 352, although possibly including to a lesser extent vehicles 354, buildings 356, and streets or roads 358. Accordingly, when an observer is presented a view of the urban area 300 in FIG. 3A, prior experience would result in an expectation that the objects observed would primarily have colors associated an artificial or man-made terrain. For example, such a terrain can include building or construction materials, associated with colors such as blacks, whites, or shades of gray. In contrast, when an observer is presented a view of the natural area 350 in FIG. 3B, prior experience would result in an expectation that the objects observed would primarily have colors associated with a natural terrain, such as browns, reds, and greens. Accordingly, when a colormap dominated by browns, reds, and greens is applied to an urban area, the observer will generally have difficulty interpreting the objects in the scene, as the objects in the urban area are not associated with the types of colors normally expected for an urban area. Similarly, when a colormap dominated by black, white, and shades of gray is applied to a natural area, the observer will generally have difficultly interpreting the types of object observed, as the objects typically encountered in a natural area are not typically associated with the types of colors normally encountered in an urban area.

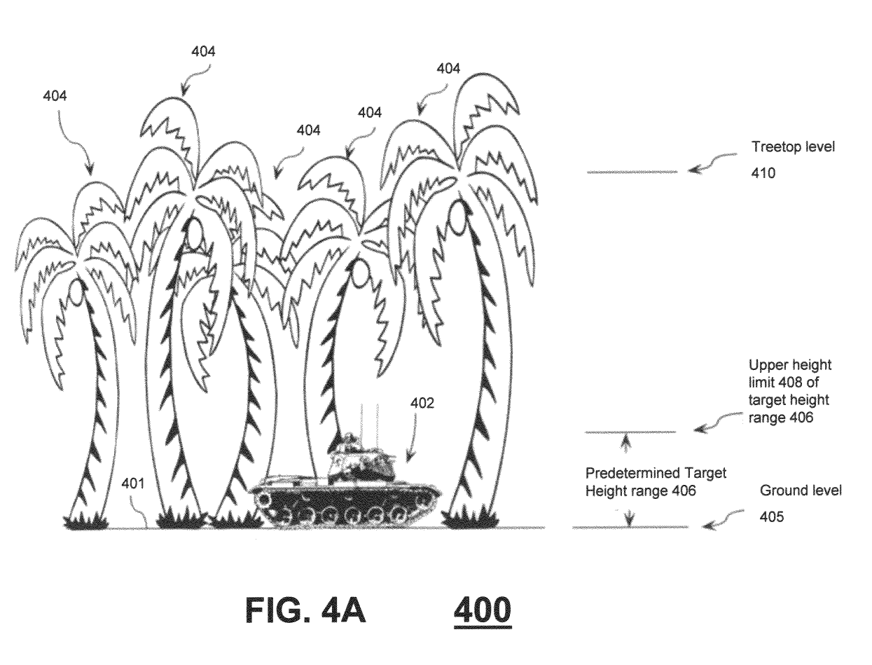

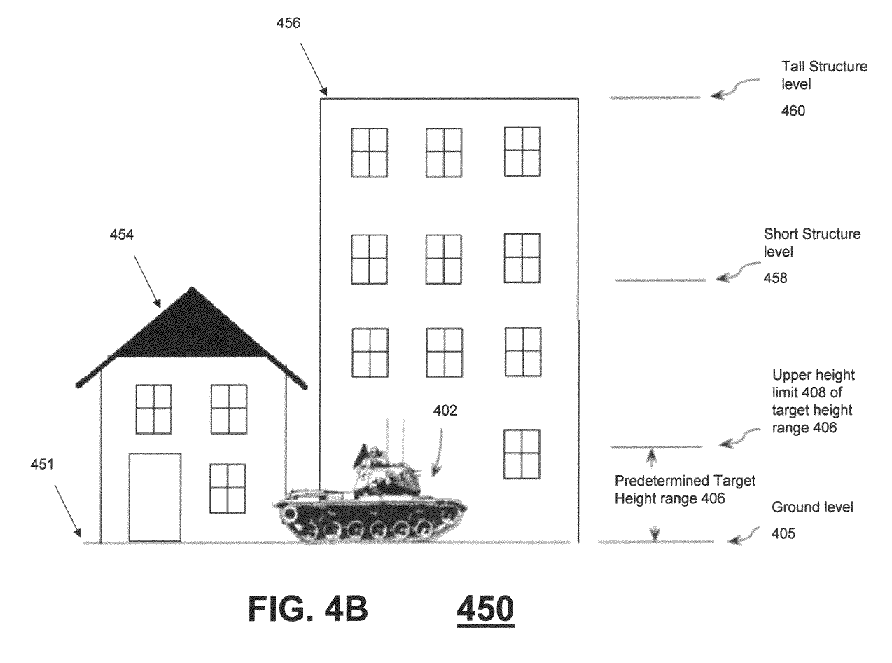

Therefore in the various embodiments of the present invention, the colormaps applied to different areas of the imaged location are selected to be appropriate for the types of objects in the location. For example, FIG. 4A conceptually shows how a colormap could developed for a natural area. FIG. 4A is a drawing that is useful for understanding certain defined altitude or elevation levels contained with a natural or rural location. FIG. 4A shows an object 402 is positioned on the ground 401 beneath a canopy of trees 404 which together can define a porous occluder. It can be observed that the trees 404 will extend from ground level 405 to a treetop level 410 that is some height above the ground 401. The actual height of the treetop level 410 will depend upon the type of trees involved. However, an anticipated tree top height can fall within a predictable range within a known geographic area. For example, FIG. 4A shows trees 404 in a tropical setting, in particular, palm trees, estimated to have a tree top height of approximately 40 meters. Accordingly, a colormap for such area can be based, at least principally, on the colors normally observed types of trees, soil, and ground vegetation in such areas. In the case of a tropical setting as shown in FIG. 4A, a colormap can be developed that provides data points at the treetop level 410 with green hues and data points at a ground level 405 with brown hues.

Similarly, FIG. 4B conceptually shows how a colormap could be developed for an urban area. FIG. 4B is a drawing that is useful for understanding certain defined altitude or elevation levels contained with an urban location. FIG. 4B shows an object 402 is positioned on the ground 451 beside short urban structures 454 (e.g., houses) and tall urban structures 456 (e.g., multi-story buildings). It can be observed that the short urban structures 454 will extend from ground level 405 to a short urban structure level 458 that is some height above the ground 451. It can also be observed that the tall urban structures 456 will extend from ground level 405 to a tall urban structure level 460 that is some height above the ground 451. The actual heights of levels 458, 460 will depend upon the type of structures involved. However, anticipated tall and short structure heights can fall within predictable ranges within known geographic areas. For example, FIG. 4B shows an urban area with 2 story homes and 4-story buildings, estimated to have a structure heights of approximately 25 and 50 meters, respectively. Accordingly, a colormap for such area can be based, at least principally, on the colors normally observed types of tall 456 and short 454 structures in such areas and the roadways in such areas. In the case of the setting shown in FIG. 4B, a colormap can be developed that provides data points at the tall structure level 460 with gray hues (e.g., concrete), data points at the short structure level 458 with black or red hues (e.g., red brick and black shingles), and data points at a ground level 405 with dark gray hues (e.g., asphalt). In some embodiments, to simplify the colormap, all structures can be associated with the same range of colors. For example, in some embodiments, an urban location can be associated with a colormap that specifies only shades of gray.

In some embodiments of the present invention, some types of objects can be located in several types of areas, such as ground-based vehicles. In general, a ground-based vehicle will generally have a height within a predetermined target height range 406. That is, the structure of such objects will extend from a ground level 405 to some upper height limit 408. The actual upper height limit will depend on the particular types of vehicles. For example a typical height of a truck, bus, or military vehicle is generally around 3.5 meters. A typical height of a passenger car is generally around 1.5 meters. Accordingly, in both the rural and urban colormaps, the data points at such heights can be provided a different color to allow easier identification of such objects, regardless of the type of scene being observed. For example, a color that is not typically encountered in the various scenes can be used to highlight the location of such objects to the observer.

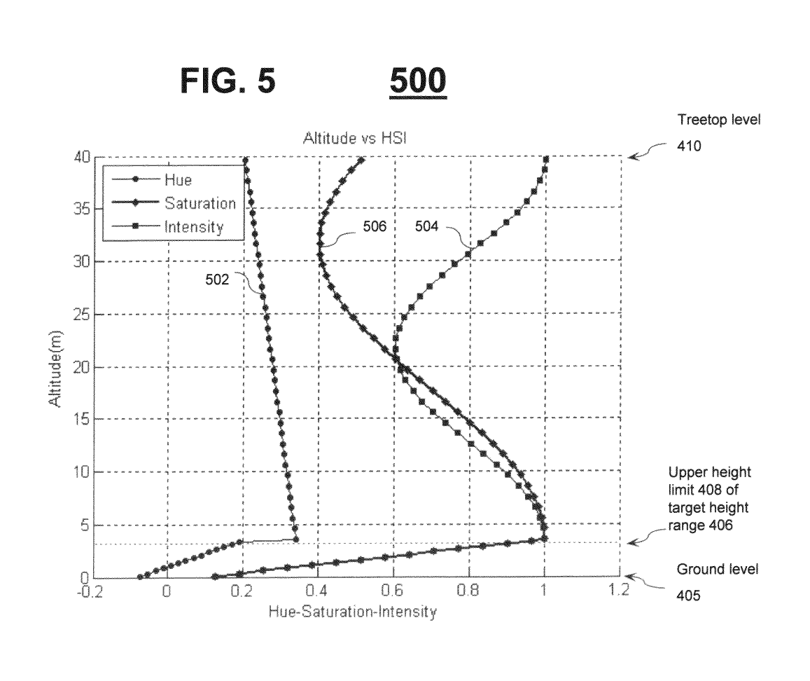

Referring now to FIG. 5, there is a graphical representation of an exemplary normalized colormap 500 for a area or location comprising natural terrain, such as in natural or rural areas, based on an HSI color space which varies in accordance with altitude or height above ground level. As an aid in understanding the colormap 500, various points of reference are provided as previously identified in FIG. 4A. For example, the colormap 500 shows ground level 405, the upper height limit 408 of an object height range 406, and the treetop level 410. In FIG. 5, it can be observed that the normalized curves for hue 502, saturation 504, and intensity 506 each vary linearly over a predetermined range of values between ground level 405 (altitude zero) and the upper height limit 408 of the target range (about 4.5 meters in this example). The normalized curve for the hue 502 reaches a peak value at the upper height limit 408 and thereafter decreases steadily and in a generally linear manner as altitude increases to tree top level 410.

The normalized curves representing saturation and intensity also have a local peak value at the upper height limit 408 of the target range. However, the normalized curves 504 and 506 for saturation and intensity are non-monotonic, meaning that they do not steadily increase or decrease in value with increasing elevation (altitude). According to an embodiment of the invention, each of these curves can first decrease in value within a predetermined range of altitudes above the target height range 408, and then increases in value. For example, it can be observed in FIG. 5 that there is an inflection point in the normalized saturation curve 504 at approximately 22.5 meters. Similarly, there is an inflection point at approximately 42.5 meters in the normalized intensity curve 506. The transitions and inflections in the non-linear portions of the normalized saturation curve 504, and the normalized intensity curve 506, can be achieved by defining each of these curves as a periodic function, such as a sinusoid. Still, the invention is not limited in this regard. Notably, the normalized saturation curve 504 returns to its peak value at treetop level, which in this case is about 40 meters.

Notably, the peak in the normalized curves 504, 506 for saturation and intensity causes a spotlighting effect when viewing the 3D point cloud data. Stated differently, the data points that are located at the approximate upper height limit of the target height range will have a peak saturation and intensity. The visual effect is much like shining a light on the tops of the target, thereby facilitating identification of the presence and type of target. The second peak in the saturation curve 504 at treetop level has a similar visual effect when viewing the 3D point cloud data. However, in this case, rather than a spotlight effect, the peak in saturation values at treetop level creates a visual effect that is much like that of sunlight shining on the tops of the trees. The intensity curve 506 shows a localized peak as it approaches the treetop level. The combined effect helps greatly in the visualization and interpretation of the 3D point cloud data, giving the data a more natural look.

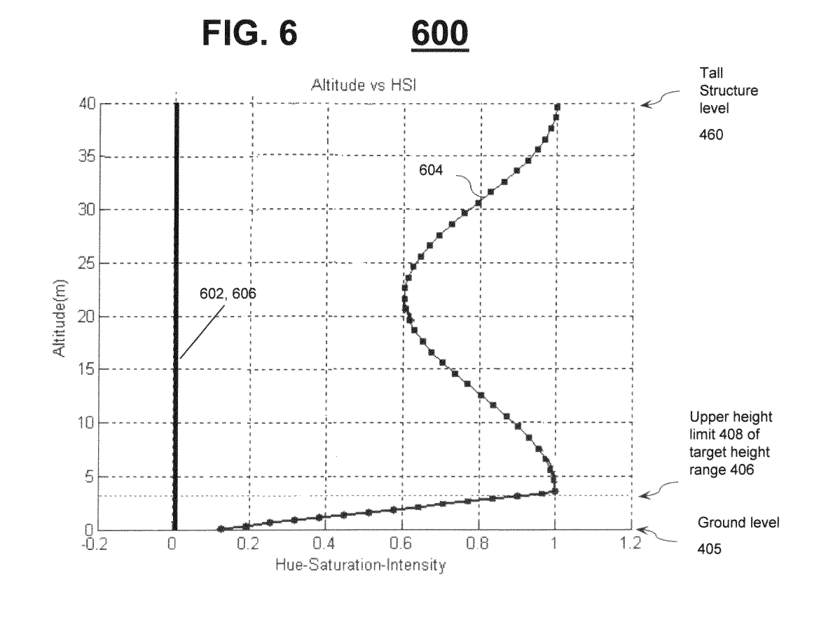

Referring now to FIG. 6, there is a graphical representation of an exemplary normalized colormap 600 for an area or location comprising artificial or man-made terrain, such as an urban area, based on an HSI color space which varies in accordance with altitude or height above ground level. As an aid in understanding the colormap 600, various points of reference are provided as previously identified in FIG. 4B. For example, the colormap 600 shows ground level 405, the upper height limit 408 of an object height range 406, and the tall structure level 460. In FIG. 6, it can be observed that the normalized curves for hue 602 and saturation 606 are zero between ground level 405 the tall structure level 460, while intensity 604 varies over the same range. Such a colormap provides a colormap of shades of gray, which represents colors commonly associated with objects in an urban location. It can also be observed from FIG. 6 that intensity 606 identically as the intensity 506 varies in FIG. 5. This provides similar spotlighting effects when viewing the 3D point cloud data associated with urban locations. This not only provides a more natural coloration for the 3D point cloud data, as described above, but also provides a similar illumination effect as in the natural areas of the 3D point cloud data. That is, adjacent areas in the 3D point cloud data comprising natural and artificial features will appear to be illuminated by the same source. However, the present invention is not limited in this regard and in other embodiments of the present invention, the intensity for different portions of the 3D point cloud can vary differently.

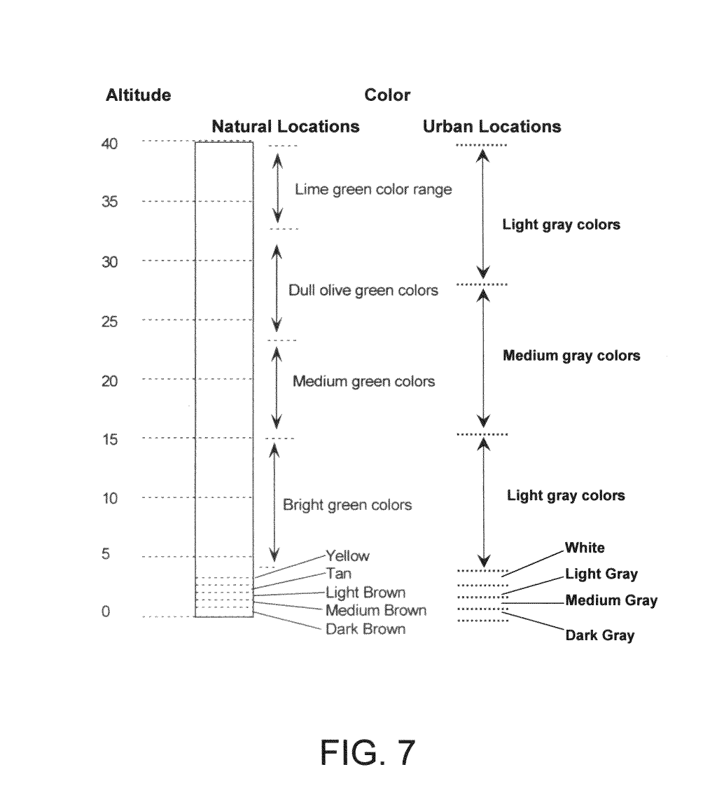

Referring now to FIG. 7, there is shown an alternative representation of the exemplary colormaps 500 and 600, associated with natural and urban locations, respectively, that is useful for gaining a more intuitive understanding of the resulting coloration for a set of 3D point cloud data. As previously described in FIG. 4A, the target height range 406 extended from the ground level 405 to and upper height limit 408. Accordingly, FIG. 7, provides a colormap for natural areas or locations with hue values corresponding to this range of altitudes extend from −0.08 (331°) to 0.20 (72°), the saturation and intensity both go from 0.1 to 1. That is, the color within the target height range 406 goes from dark brown to yellow, as shown by the exemplary colormap for natural locations in FIG. 7.

Referring again to the exemplary colormap for natural locations in FIG. 7, the data points located at elevations extending from the upper height limit 408 of target height range to the tree-top level 410 go from hue values of 0.20 (72°) to 0.34 (122.4°), intensity values of 0.6 to 1.0 and saturation values of 0.4 to 1. That is, the color within the upper height limit 408 of the target height range and the tree-top level 410 of the trees areas goes from brightly lit greens, to dimly lit with low saturation greens, and then returns to brightly lit high saturation greens, as shown in FIG. 7. This is due to the use of sinusoids for the saturation and intensity colormap but the use of a linear colormap for the hue.

The colormap in FIG. 7 for natural areas or locations shows that the hue of point cloud data located closest to the ground will vary rapidly for z axis coordinates corresponding to altitudes from 0 meters to the approximate upper height limit 408 of the target height range. In this example, the upper height limit is about 4.5 meters. However, embodiments of the present invention are not limited in this regard. For example, within this range of altitudes data points can vary in hue (beginning at 0 meters) from a dark brown, to medium brown, to light brown, to tan and then to yellow (at approximately 4.5 meters). For convenience, the hues in FIG. 7 for the exemplary colormap for natural locations are coarsely represented by the designations dark brown, medium brown, light brown, and yellow. However, it should be understood that the actual color variations used in a colormap for natural areas or locations can be considerably more subtle as represented in FIG. 7.

Referring again to the exemplary colormap for natural locations in FIG. 7, dark brown is advantageously selected for point cloud data in natural areas or locations at the lowest altitudes because it provides an effective visual metaphor for representing soil or earth. Hues then steadily transition from this dark brown hue to a medium brown, light brown and then tan hue, all of which are useful metaphors for representing rocks and other ground cover. Of course, the actual hue of objects, vegetation or terrain at these altitudes within any natural scene can be other hues. For example the ground can be covered with green grass. However, in some embodiments of the present invention for purposes of visualizing 3D point cloud data, it is has been found to be useful to generically represent the low altitude (zero to five meters) point cloud data in these hues, with the dark brown hue nearest the surface of the earth.

The colormap in FIG. 7 for natural areas or locations also defines a transition from a tan hue to a yellow hue for point cloud data having a z coordinate corresponding to approximately 4.5 meters in altitude. Recall that 4.5 meters is the approximate upper height limit 408 of the target height range 406. Selecting the colormap for the natural areas to transition to yellow at the upper height limit of the target height range has several advantages. In order to appreciate such advantages, it is important to first understand that the point cloud data located approximately at the upper height limit 406 can often form an outline or shape corresponding to a shape of an object in the scene.

By selecting the colormap for natural areas or locations in FIG. 7 to display 3D point cloud data in a yellow hue at the upper height limit 408, as shown in FIG. 5, several advantages are achieved. The yellow hue provides a stark contrast with the dark brown hue used for point cloud data at lower altitudes. This aids in human visualization of vehicles by displaying the vehicle outline in sharp contrast to the surface of the terrain. However, another advantage is also obtained. The yellow hue is a useful visual metaphor for sunlight shining on the top of the vehicle. In this regard, it should be recalled that the saturation and intensity curves also show a peak at the upper height limit 408. The visual effect is to create the appearance of intense sunlight highlighting the tops of vehicles. The combination of these features aid greatly in visualization of targets contained within the 3D point cloud data.

Referring once again to the exemplary colormap for natural locations in FIG. 7, it can be observed that for heights immediately above the upper height limit 408 (approximately 4.5 meters), the hue for point cloud data in natural areas or locations is defined as a bright green color corresponding to foliage. The bright green color is consistent with the peak saturation and intensity values defined in FIG. 5. As described above with respect to FIG. 5, the saturation and intensity of the bright green hue will decrease from the peak value near the upper height limit 408 (corresponding to 4.5 meters in this example). The saturation curve 50 has a null corresponding to approximately an altitude of about 22 meters. The intensity curve has a null at an altitude corresponding to approximately 42 meters. Finally, the saturation and intensity curves 504, 506 each have a second peak at treetop level 410. Notably, the hue remains green throughout the altitudes above the upper height limit 408. Hence, the visual appearance of the 3D point cloud data above the upper height limit 408 of the target height range 406 appears to vary from a bright green color, to medium green color, dull olive green, and finally a bright lime green color at treetop level 410, as shown by the transitions in FIG. 7 for the exemplary colormap for natural locations. The transition in the appearance of the 3D point cloud data for these altitudes will correspond to variations in the saturation and intensity associated with the green hue as defined by the curves shown in FIG. 5.

Notably, the second peak in saturation and intensity curves 504, 506 occurs at treetop level 410. As shown in the exemplary color map for natural locations in FIG. 7, the hue is a lime green color. The visual effect of this combination is to create the appearance of bright sunlight illuminating the tops of trees within a natural scene. In contrast, the nulls in the saturation and intensity curves 504, 506 will create the visual appearance of shaded understory vegetation and foliage below the treetop level.

A similar coloration effect is shown in FIG. 7 for 3D point cloud data for areas or locations dominated by man-made or artificial features, such as urban locations. As previously described in FIG. 4B, the target height range 406 extended from the ground level 405 to and upper height limit 408. Accordingly, FIG. 7 provides a exemplary colormap for urban areas with intensity values corresponding to this range of altitudes extending from 0.1 to 1. That is, the color within the target height range 406 goes from dark grey to white, as shown in FIG. 7.

Referring again to the exemplary colormap for urban locations in FIG. 7, the data points located at elevations extending from the upper height limit 408 of target height range to the tall structure level 460 go from intensity values of 0.6 to 1.0, as previously described in FIG. 6. That is, the color within the upper height limit 408 of the target height range and the tall structure level 460 goes from white or light grays, to medium grays, and then returns to white or light grays, as shown by the transitions in FIG. 7 for the exemplary colormap for urban locations. This is due to the use of sinusoids for the intensity colormap.

The colormap in FIG. 7 shows that the intensity of point cloud data located closest to the ground in locations dominated by artificial or man-made features, such as urban areas, will vary rapidly for z axis coordinates corresponding to altitudes from 0 meters to the approximate upper height limit 408 of the target height range. In this example, the upper height limit is about 4.5 meters. However, embodiments of the present invention are not limited in this regard. For example, within this range of altitudes data points can vary in colors (beginning at 0 meters) from a dark gray, to medium gray, to light gray, and then to white (at approximately 4.5 meters). For convenience, the colors in FIG. 7 for an urban location are coarsely represented by the designations dark gray, medium gray, light gray, and white. However, it should be understood that the actual color variations used in the colormap for urban locations and other locations dominated by artificial or man-made features is considerably more subtle as represented in FIG. 7.

Referring again to exemplary colormap for urban areas in FIG. 7, dark grey is advantageously selected for point cloud data at the lowest altitudes because it provides an effective visual metaphor for representing roadways. Within this exemplary colormap, hues steadily transition from this dark grey to a medium grey, light grey and then while, all of which are useful metaphors for representing signs, signals, sidewalks, alleys, stairs, ramps, and other types of pedestrian-accessible or vehicle-accessible structures. Of course, the actual color of objects at these altitudes can be other colors. For example a street or roadway can have various markings thereon. However, for purposes of visualizing 3D point cloud data in urban locations and other locations dominated by artificial or man-made features, it is has been found to be useful to generically represent the low altitude (zero to five meters) point cloud data in shades of gray, with the dark gray nearest the surface of the earth.

The exemplary colormap in FIG. 7 for urban areas also defines a transition from a light grey to white for point cloud data in urban locations having a z coordinate corresponding to approximately 4.5 meters in altitude. Recall that 4.5 meters is the approximate upper height limit 408 of the target height range 406. Selecting the colormap for the urban areas to transition to white at the upper height limit of the target height range has several advantages. In order to appreciate such advantages, it is important to first understand that the point cloud data located approximately at the upper height limit 406 can often form an outline or shape corresponding to a shape of an object or interest in the scene.

By selecting the exemplary colormap for urban areas in FIG. 7 to display 3D point cloud data for urban locations in white at the upper height limit 408, several advantages are achieved. The white color provides a stark contrast with the dark gray color used for point cloud data at lower altitudes. This aids in human visualization of, for example, vehicles by displaying the vehicle outline in sharp contrast to the surface of the terrain. However, another advantage is also obtained. The white color is a useful visual metaphor for sunlight shining on the top of the object. In this regard, it should be recalled that the intensity curves also show a peak at the upper height limit 408. The visual effect is to create the appearance of intense sunlight highlighting the tops of objects, such as vehicles. The combination of these features aid greatly in visualization of targets contained within the 3D point cloud data.

Referring once again to the exemplary colormap for urban areas in FIG. 7, it can be observed that for heights immediately above the upper height limit 408 (approximately 4.5 meters), the color for point cloud data in an urban location is defined as a light gray transitioning to a medium gray up to about 22 meters at a null of intensity curve 604. Above 22 meters, the color for point cloud data in an urban location is defined to transition from a medium gray to a light gray or white, with intensity peaking at the tall structure level 460. The visual effect of this combination is to create the appearance of bright sunlight illuminating the tops of the tall structures within an urban scene. The null in the intensity curve 604 will create the visual appearance of shaded sides of buildings and other structures below the tall structure level 460.

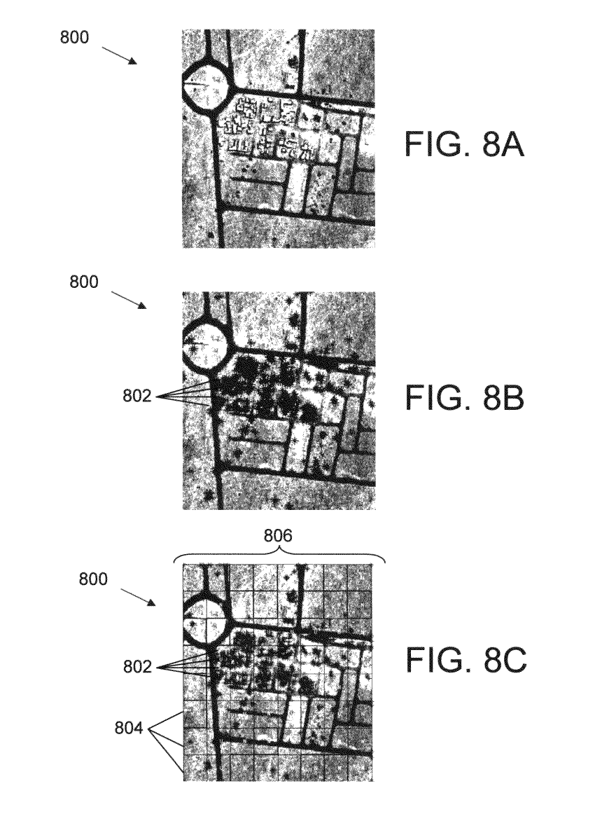

As described above, prior to applying the various colormaps to different portions of the imaged location, a scene tag or classification is obtained for each portion of the imaged location. This process is conceptually described with respect to FIGS. 8A-8C. First, image data from radiometric image 800 of a location of interest for which 3D point cloud data has been collected, such as the exemplary image in FIG. 8A, can be obtained as described above with respect to FIG. 1. The image data, although not including any elevation information, will include size, shape, and edge information for the various objects in the location of interest. Such information can be utilized in the present invention for scene tagging. That is, such information can be used to determine the number of one or more type of features located in a particular portion of the 3D point cloud and these features can be used to determine the scene tags for various portions of the 3D point cloud. For example, a corner detector could be used as a determinant of whether a region is populated by natural features (trees or water for example) or man-made features (such as buildings or vehicles). For example, as shown in FIG. 3A, an urban area will tend to have more corner features, due to the larger number of buildings 302, roads 306, and other man-made structures generally found in an urban area. In contrast, as shown in FIG. 3B, the natural area will tend to include a smaller number of such corner features, due to the irregular patterns and shapes typically associated with natural objects. Accordingly, after obtaining the radiometric image 800 for the location of interest, the radiometric image 800 can be analyzed using a feature detection algorithm. For example, FIG. 8B shows the result of analyzing FIG. 8A using a corner detection algorithm. For illustrative purposes, the corners found by the corner detection algorithm in the radiometric image 800 are identified by markings 802.

Although feature detection for FIG. 8B is described with respect to corner detection, embodiments of the present invention are not limited in this regard. In the various embodiments of the present invention, any types of features can be used for scene tagging and therefore identified, including but not limited to edge, corner, blob, and/or ridge detection. Furthermore, in some embodiments of the present invention, the features identified can be further used to determine the locations of objects of one or more particular sizes. Determining the number of features in an radiometric image can accomplished by applying various types of feature detection algorithms to the radiometric image data. For example, corner detection algorithms can include Harris operator, Shi and Tomasi, level curve curvature, smallest univalue segment assimilating nucleus (SUSAN), and features from accelerated segment test (FAST) algorithms, to name a few. However, any feature detection algorithm can be used for detecting particular types of features in the radiometric image.

However, embodiments of the present invention are not limited solely to geometric methods. In some embodiments of the present invention, analysis of the radiometric data itself can be used for scene tagging or classification. For example, a spectral analysis can be performed to find areas of vegetation using the near (˜750-900 nm) and/or mid (˜1550-1750 nm) infrared (IR) band and red (R) band (˜600-700 nm) from a multi-spectral image. In such embodiments, calculation of the normalized difference vegetation index (NDVI=(IR−R)/(IR+R)) can be used to identify regions of healthy vegetation. In such an analysis, areas can be tagged according to the amount of healthy vegetation (e.g., <0.1 no vegetation, 0.2-0.3 shrubs or grasslands, 0.6-0.8 temperate and/or tropical rainforest). However, the various embodiments of the present invention are not limited to identifying features using any specific bands. In the various embodiments of the present invention, any number and types of spectral bands can be evaluated to identify features and to provide tagging or classification of features or areas.

In the various embodiments of the present invention, feature detection is not limited to one methods. Rather in the various embodiments of the present invention, any number of feature detection methods can be used. For example, a combination of geometric and radiometric analysis methods can be used to identify features in the radiometric image 800.

Once the features of interest (for classification or tagging purposes) are detected in the radiometric image 800, the radiometric image 800 can be divided into a plurality of regions 804 to form a grid 806, for example, as shown in FIG. 8C. Although a grid 806 of square-shaped regions 804 is shown in FIG. 8C, the present invention is not limited in this regard and the radiometric image can be divided according to any method. A threshold limit can be placed on the number of corners in this region. In general, such threshold limits can be determined experimentally and can vary according to geographic location. In general, in the case of corner-based classification of urban and natural areas, a typical urban area is expected to contain a larger number of pixels associated with corners. Accordingly, if the number of corners in a region of the radiometric image is greater than or equal to the threshold value, an urban colormap is used for the corresponding portion of 3D point cloud data.

Although an radiometric image can be assigned into gridded into regions, in some embodiments of the present invention, the radiometric image can be divided into regions based on the locations of features (i.e., markings 802). For example, the regions 804 can be selected by first identifying locations within the radiometric image 800 with large numbers of identified features and centering the grid 806 to provide minimum number of regions for such areas. The position of the first ones of regions 804 is selected such that a minimum number is used for such locations. The designation of other ones regions 804 can then proceed from this initial placement. After a colormap is selected for each portion of the radiometric image, the 3D point cloud data can be registered or aligned with the radiometric image. Such registration can be based on meta-data associated with the radiometric image and the 3D point cloud data, as described above. Alternatively, in embodiments, where a spectral analysis method is used, each pixel of the radiometric image could be considered a separate region. As a result, the colormap can vary from pixel to pixel in the radiometric image.

Although only one exemplary embodiment of a grid is illustrated in FIG. 8C, the present invention is not limited in this regard. In the various embodiments of the present invention, the 3D point cloud data can be divided into regions of any size and/or shape. For example, using dimensions of the grid that are smaller as compared to those in FIG. 8C can be used to improve the color resolution of the final fused image. For example, if one of grids 804 includes an area with both buildings and trees, such as area 300 in FIG. 3A, classifying the one grid as solely urban and applying a corresponding color map would result in many trees and other natural features having an incorrect coloration. However, by using smaller sized regions, the likelihood that trees and other natural features are colored according to surrounding urban features is decreased, as the number of regions being tagged as rural or natural is likely increased. In other words, if multiple grids are applied to the area 300 in FIG. 3A, area 300 would not be considered to be solely urban. Rather, a first colormap could be applied to grids containing trees 308 and a second colormap to grids containing buildings 302. Similarly, such smaller sized grids increase the likelihood of buildings 356 in area 350 of FIG. 3B to be colored correctly rather than being colored according to surrounding trees 352.

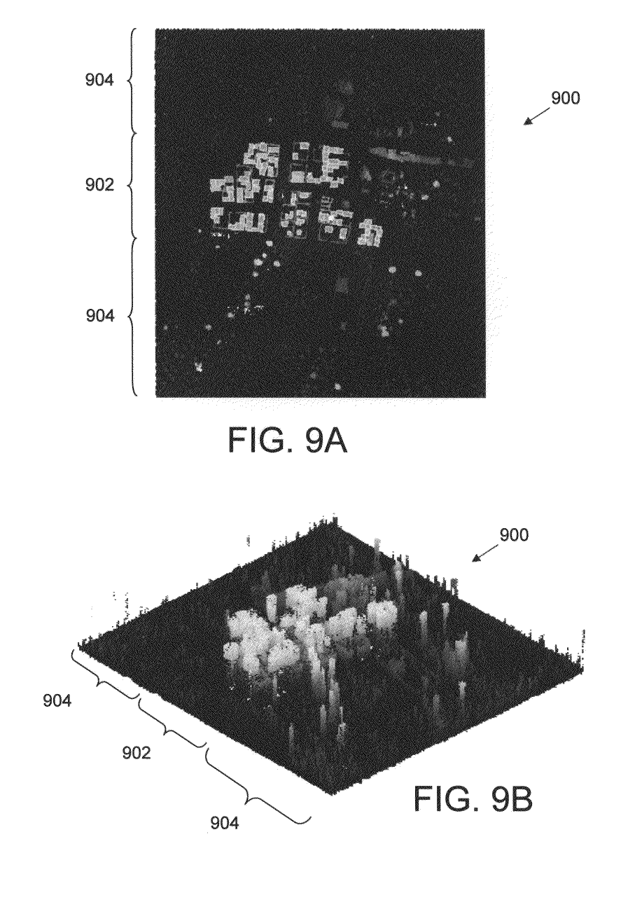

After the 3D point cloud data and the radiometric image are registered, the colormap for each of regions 804 is then used to add color data to the 3D point cloud data. A set of exemplary results of this process is shown in FIGS. 9A and 9B. FIGS. 9A and 9B show top-down and perspective views of 3D point cloud data 900 after the addition of color data in accordance with an embodiment of the present invention. In particular, FIGS. 9A and 9B illustrate 3D point cloud data 900 including colors based on the identification of natural and urban locations and the application of the HSI values defined for natural and urban locations in FIGS. 5 and 6, respectively. As shown in FIGS. 9A and 9B, buildings 902 in the point cloud data 900 are now effectively color coded in grayscale, according to FIG. 6, to facilitate their identification. Similarly, other objects 904 in the point cloud data 900 are also effectively in the point cloud data 900 are also now effectively color coded, according to FIG. 5, to facilitate their identification as natural areas. Accordingly, the combination of colors simplifies visualization and interpretation of the 3D point cloud data and presents the 3D point cloud data in a more meaningful way to the viewer.

Although classification of portions of a 3D point cloud has been described with respect to exemplary urban or natural scene tags and corresponding colormaps, embodiments of the present invention are not limited solely to these two types of scene tags. In the various embodiments of the present invention, any number and types of scene tags can be used. For example, one classification scheme can include tagging for agricultural or semi-agricultural areas (and corresponding colormaps) in addition to natural and urban area tagging. Furthermore, for each of these area, subclasses of these area can also be tagged and have different colormaps. For example, agricultural and semi-agricultural areas can be tagged according to crop or vegetation type, as well as use type. Urban areas can be tagged according to use as well (e.g., residential, industrial, commercial, etc.). Similarly, natural areas can be tagged according to vegetation type or water features present. However, the various embodiments of the present invention are not limited solely to any single type of classification scheme and any type of classification scheme can be used with the various embodiments of the present invention.

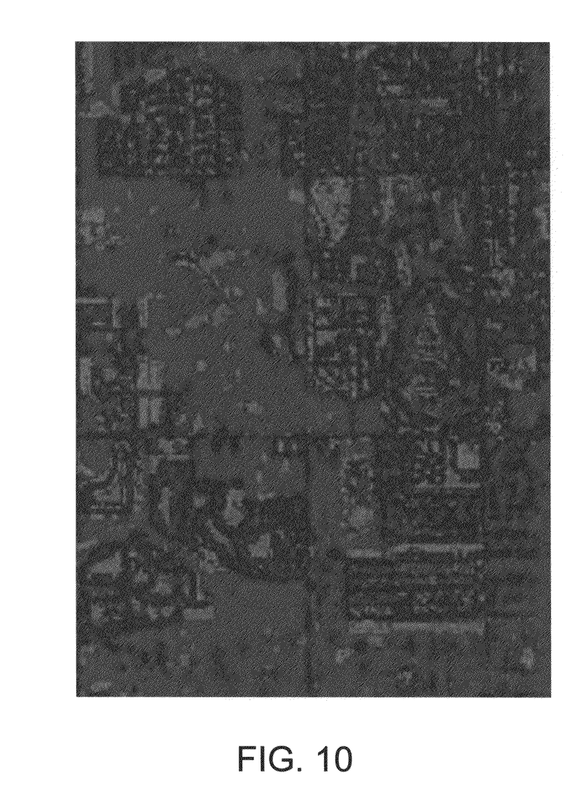

Furthermore, as previously described, each pixel of the radiometric image can be considered to be a different area of the radiometric image. Consequently, spectral analysis methods can be further utilized to identify specific types of objects in radiometric images. An exemplary result of such a spectral analysis is shown in FIG. 10. As shown in FIG. 10, a spectral analysis can be used to identify different types of features based on wavelengths or bands that are reflected and/or absorbed by objects. FIG. 10 shows that for some wavelengths of electromagnetic radiation, vegetation (green), buildings and other structures (purple), and bodies of water (cyan) can generally be identified by evaluating one or more spectral bands of a multi- or hyper-spectral image. Such results can be combined with 3D point cloud data to provide more accurate tagging of objects.

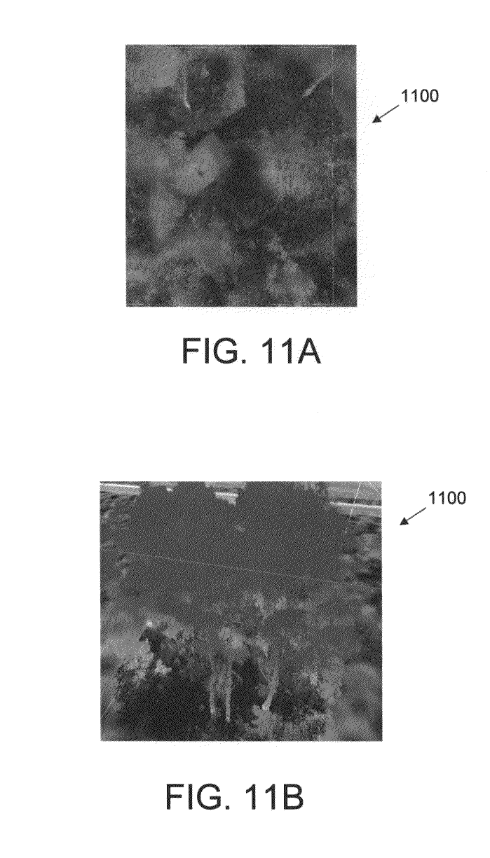

For example, a normalized difference vegetation index (NDVI) values, as previously described, can be used to identify vegetation and other features in a radiometric image and apply a corresponding colormap to associated points in the 3D point cloud data. For example, an exemplary result of such feature tagging is shown in FIGS. 11A and 11B. FIGS. 11A and 11B show top-down and perspective views of 3D point cloud data after the addition of color data by tagging using NVDI values in accordance with an embodiment of the present invention. As shown in FIGS. 11A and 11B, 3D point cloud data associated with trees and other vegetation is colored using a colormap associated with various hues of green. Other features, such as the ground or other objects are colored with a colormap associated with various hues of black, brown, and duller yellows.

Although the various embodiments of the present invention have been discussed in terms of substantially constant elevation ground level, in many cases the ground level elevation can vary. If not accounted for, such elevation variations in the ground level within a scene represented by 3D point cloud data can make scene and object visualization difficult.

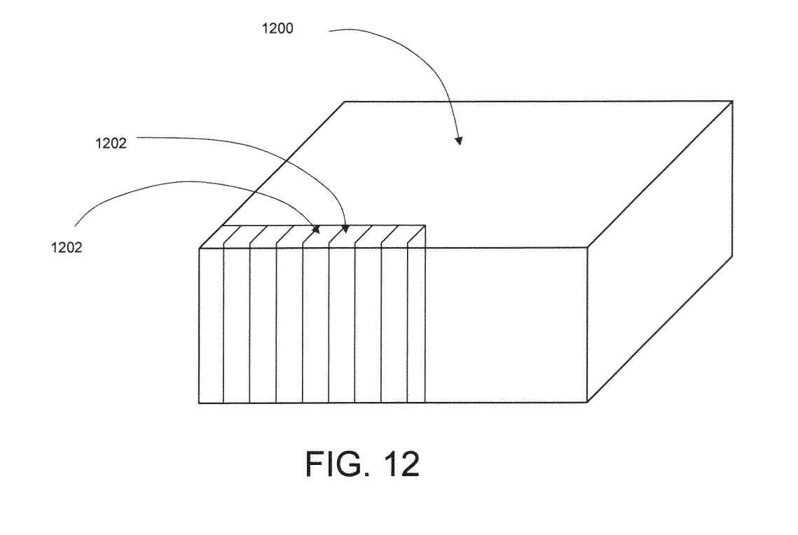

In some embodiments of the present invention, in order to account for variations in terrain elevation when applying the colormaps to the 3D data, the volume of a scene which is represented by the 3D point cloud data can be divided into a plurality of sub-volumes. This is conceptually illustrated with respect to FIG. 12. As shown in FIG. 12, each frame 1200 of 3D point cloud data can be divided into a plurality of sub-volumes 1202. Individual sub-volumes 1202 can be selected that are considerably smaller in total volume as compared to the entire volume represented by each frame of 3D point cloud data. The exact size of each sub-volume 1202 can be selected based on the anticipated size of selected objects appearing within the scene as well as the terrain height variation. Still, the present invention is not limited to any particular size with regard to sub-volumes 1202.

Each sub-volume 1002 can be aligned with a particular portion of the surface of the terrain represented by the 3D point cloud data. According to an embodiment of the invention, a ground level 405 can be defined for each sub-volume. The ground level 405 can be determined as the lowest altitude 3D point cloud data point within the sub-volume. For example, in the case of a LIDAR type ranging device, this will be the last return received by the ranging device within the sub-volume. By establishing a ground reference level for each sub-volume, it is possible to ensure that the colormaps used for the various portions of the 3D point cloud will be properly referenced to a true ground level for that portion of the scene.

In light of the foregoing description of the invention, it should be recognized that the present invention can be realized in hardware, software, or a combination of hardware and software. A method in accordance with the inventive arrangements can be realized in a centralized fashion in one processing system, or in a distributed fashion where different elements are spread across several interconnected systems. Any kind of computer system, or other apparatus adapted for carrying out the methods described herein, is suited. A typical combination of hardware and software could be a general purpose computer processor or digital signal processor with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. I t will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A method for improving visualization and interpretation of spatial data of a location, comprising:
selecting a first scene tag from a plurality of scene tags for a first portion of a radiometric image data of said location;
selecting a first portion of said spatial data, said spatial data comprising a plurality of three-dimensional (3D) data points associated with said first portion of said radiometric image data;
selecting a first color space function for said first portion of said spatial data from a plurality of color space functions, said selecting based on said first scene tag, and each of said plurality of color space functions defining hue, saturation, and intensity (HSI) values as a function of an altitude coordinate of said plurality of 3D data points; and
displaying said first portion of said spatial data using said HSI values selected from said first color space function using said plurality of 3D data points associated with said first portion of said spatial data,
wherein said plurality of scene tags are associated with a plurality of classifications, and wherein each of said plurality of color space functions represents a different pre-defined variation in said HSI values associated one of said plurality of classifications.

2. The method of claim 1, wherein said selecting said first scene tag further comprises:
dividing said radiometric image data into a plurality of portions; and
selecting one of said plurality of scene tags for each of said plurality of portions.

3. The method of claim 1, wherein said selecting said first scene tag further comprises:
recognizing one or more types of features in said first portion of said radiometric image data; and
determining said first scene tag for said first portion of said spatial data based at least one of said types of features recognized in said first portion of said radiometric image data.

4. The method of claim 3, wherein said recognizing further comprises identifying said types of features based on performing at least one of a geometric analysis of said first portion of said radiometric image data and a spectral analysis of said first portion of said radiometric image data.

5. The method of claim 4, wherein said performing said geometric analysis comprises detecting at least one among edge features, corner features, blob features, or ridge features.

6. The method of claim 4, wherein said radiometric image data comprises image data for a plurality of spectral bands, and wherein said performing said spectral analysis comprises detecting features by evaluating at least one of said plurality of spectral bands.

7. The method of claim 6, wherein said evaluating said difference comprises computing a normalized vegetation value index (NVDI) values for each pixel in said radiometric image data, and wherein said recognizing further comprises identifying vegetation features based on said NVDI values.

8. A system for improving visualization and interpretation of spatial data of a location, comprising:
a storage element for receiving said spatial data and radiometric image data associated with said location; and
a processing element communicatively coupled to said storage element, wherein the processing element is configured for:
selecting a first scene tag from a plurality of scene tags for a first portion of a radiometric image data of said location;
selecting a first portion of said spatial data, said first portion of said spatial data comprising a plurality of three-dimensional (3D) data points associated with said first portion of said radiometric image data;
selecting a first color space function for said first portion of said spatial data from a plurality of color space functions, said selecting based on said first scene tag, and each of said plurality of color space functions defining hue, saturation, and intensity (HSI) values as a function of an altitude coordinate of said plurality of 3D data points; and
displaying said first portion of said spatial data using said HSI values selected from said first color space function using said plurality of 3D data points associated with said first portion of said spatial data,
wherein said plurality of scene tags are associated with a plurality of classifications, and wherein each of said plurality of color space functions represents a different pre-defined variation in said HSI values associated one of said plurality of classifications.

9. The system of claim 8, wherein said processing element is further configured during said selecting of said first scene tag for:
dividing said radiometric image data into a plurality of portions; and
selecting one of said plurality of scene tags for each of said plurality of portions.

10. The system of claim 8, wherein said processing element is further configured during said selecting of said first scene tag for:
recognizing one or more types of features in said first portion of said radiometric image data; and
determining said first scene tag for said first portion of said spatial data based at least one of said types of features recognized in said first portion of said radiometric image data.

11. The system of claim 10, wherein said processing element is further configured during said recognizing for:
identifying said types of features based on performing at least one of a geometric analysis of said first portion of said radiometric image data and a spectral analysis of said first portion of said radiometric image data.

12. The system of claim 11, wherein said performing said geometric analysis comprises detecting at least one among edge features, corner features, blob features, or ridge features.

13. The system of claim 11, wherein said radiometric image data comprises image data for a plurality of spectral bands, and wherein said performing said spectral analysis comprises detecting features by evaluating at least one of said plurality of spectral bands.

14. The system of claim 13, wherein said processing element is further configured during said evaluating said difference for computing a normalized vegetation value index (NVDI) values for each pixel in said radiometric image data, and wherein said processing element is further configured during said recognizing for identifying vegetation features based on said NVDI values.

15. A computer-readable medium, having stored thereon a computer program for improving visualization and interpretation of spatial data of a location, the computer program comprising a plurality of code sections, the plurality of code sections executable by a computer for causing the computer to perform the steps of:
selecting a first scene tag from a plurality of scene tags for a first portion of a radiometric image data of said location;
selecting a first portion of said spatial data, said spatial data comprising a plurality of three-dimensional (3D) data points associated with said first portion of said radiometric image data;
selecting a first color space function for said first portion of said spatial data from a plurality of color space functions, said selecting based on said first scene tag, and each of said plurality of color space functions defining hue, saturation, and intensity (HSI) values as a function of an altitude coordinate of said plurality of 3D data points; and
displaying said first portion of said spatial data using said HSI values selected from said first color space function using said plurality of 3D data points associated with said first portion of said spatial data,
wherein said plurality of scene tags are associated with a plurality of classifications, and wherein each of said plurality of color space functions represents a different pre-defined variation in said HSI values associated one of said plurality of classifications.

16. The computer-readable medium of claim 15, wherein said selecting said first scene tag further comprises code sections for:
dividing said radiometric image data into a plurality of portions; and
selecting one of said plurality of scene tags for each of said plurality of portions.

17. The computer-readable medium of claim 15, wherein said selecting said first scene tag further comprises code sections for:
recognizing one or more types of features in said first portion of said radiometric image data; and
determining said first scene tag for said first portion of said spatial data based at least one of said types of features recognized in said first portion of said radiometric image data.

18. The computer-readable medium of claim 17, wherein said recognizing further comprises code sections for:
identifying said types of features based on performing at least one of a geometric analysis of said first portion of said radiometric image data and a spectral analysis of said first portion of said radiometric image data.

19. The computer-readable medium of claim 18, wherein said performing said geometric analysis comprises code sections for detecting at least one among edge features, corner features, blob features, or ridge features.

20. The computer-readable medium of claim 19, wherein said radiometric image data comprises image data for a plurality of spectral bands, and wherein said performing said spectral analysis comprises code sections for computing a normalized vegetation value index (NVDI) values for each pixel in said radiometric image data, and wherein said recognizing further comprises code sections for identifying vegetation features based on said NVDI values.
